(19) United States
(12) Patent Application Publication
(10) Pub. No.: US 2024/0390709 A1
(43) Pub. Date: Nov. 28, 2024

(54) PNEUMATIC WHISTLE

(71) Applicant: DRAEGER SAFETY AG & Co. KGaA, Lubeck (DE)

(72) Inventors: James Andrew FARNABY, Newcastle upon Tyne (GB); Emilie LAGEAT, Northumberland (GB); Iain BRECHTELSBAUER, Whitley Bay (GB)

(21) Appl. No.: 18/670,035

(22) Filed: May 21, 2024

(30) Foreign Application Priority Data
May 26, 2023 (EP) 23175863.2

(51) Int. Cl. A62B 9/00

(52) U.S. Cl. CPC A62B 9/006

(57) ABSTRACT

There is disclosed a pneumatic whistle for a breathing apparatus comprising: a whistle body comprising an opening; a whistle flute connected to the whistle body; a fluid ingress path formed at an interface between the whistle body and the whistle flute; a fastener configured to secure the whistle flute to the whistle body, the fastener forming a fluid ingress point on the fluid ingress path; a sealing element configured to form a seal between the whistle body and the whistle flute on the fluid ingress path, so as to inhibit fluid ingress along the fluid ingress path beyond the sealing element; wherein the sealing element is arranged downstream of the fluid ingress point along the fluid ingress path. Also disclosed is a breathing apparatus comprising a pneumatic whistle.

### CROSS-REFERENCE TO RELATED APPLICATIONS

This application claims priority to European Application No. 23175863.2, filed May 26, 2024, the entire contents of which being fully incorporated herein by reference.

### BACKGROUND

Self-contained breathing apparatus (SCBA) products are typically used by fire fighters to provide safe breathing air in environments with contaminated atmospheres. As part of the required functionality of SCBA products, an audible pressure level alarm must be provided. Such alarms must be capable of alerting the user when the breathing gas cylinder pressure reduces below a certain level, and therefore that a limited amount of breathing gas remains. Typically, the audible alarm sound is generated using high pressure air to produce a whistle noise, and the whistle is configured to sound automatically when the breathing gas cylinder pressure drops below a predetermined threshold.

Once a SCBA product has been used, it requires cleaning before being reused to remove contaminants. Liquids such as water and detergents are often used the cleaning process. During cleaning of typical SCBA products, liquid can enter the pneumatic circuit of the product through the alarm whistle opening or other openings associated with the alarm. Any liquid trapped inside the pneumatic circuit could freeze or otherwise cause blockages in the circuit, preventing correct operation. Therefore, a cap is often installed over the whistle alarm to prevent liquid entering through the alarm whistle port. However, even when a cap is used, some liquid can enter through other openings.

Therefore, there exists a need for a new type of audible alarm which can more comprehensively and reliably resist liquid ingress during cleaning.

### SUMMARY OF THE INVENTION

In a first aspect, there is provided a pneumatic whistle for a breathing apparatus comprising: a whistle body comprising an opening; a whistle flute connected to the whistle body; a fluid ingress path formed at an interface between the whistle body and the whistle flute; a fastener configured to secure the whistle flute to the whistle body, the fastener forming a fluid ingress point on the fluid ingress path; a sealing element configured to form a seal between the whistle body and the whistle flute on the fluid ingress path, so as to inhibit fluid ingress along the fluid ingress path beyond the sealing element; wherein the sealing element is arranged downstream of the fluid ingress point along the fluid ingress path.

The whistle flute should be understood to mean the part of the pneumatic whistle which produces a whistle sound when air or another fluid flows through or past it. The whistle body should be understood to mean the part of the pneumatic whistle which connects the whistle flute to a pneumatic system such as the pneumatic circuit of a breathing apparatus. A whistle body may contain a valve or other equipment for controlling the flow of fluid to the whistle flute.

Downstream should be understood to mean a point or region on the fluid ingress path (i.e., at the interface between the whistle flute and whistle body) which a fluid may flow towards after entering the fluid ingress path at the fluid ingress point. In other words, a downstream location on the fluid ingress path is a point that is closer to the interior of the pneumatic whistle. The fluid ingress path may extend between an inlet point at the exterior of the pneumatic whistle (i.e., where the whistle flute and whistle body meet at the exterior of the pneumatic whistle), and an outlet point at the interior of the pneumatic whistle (i.e., where the whistle flute and whistle body meet at the interior of the pneumatic whistle). The fluid ingress point may extend between, or otherwise provide fluid communication between, the exterior of the pneumatic whistle and an intermediate point on the fluid ingress path between the inlet point and the outlet point, thereby providing a further location for fluid ingress in addition to the inlet point.

One of the whistle body and the whistle flute may comprise a protruding portion and the other of the whistle body and the whistle flute may comprise a receiving portion configured to receive the protruding portion so as to form the fluid ingress path at an interface between the protruding portion and the receiving portion.

The sealing element may be disposed proximate a distal end of the protruding portion and may seal against a seal seat on a surface of the receiving portion. The sealing element or elements may be provided on either or both of the whistle flute or the whistle body. Multiple sealing elements may be provided on the fluid ingress path.

The fastener may be installable through a hole proximate a distal end of the receiving portion and into a fastener seat in a base of the protruding portion. The fastener may be, for instance, a threaded screw such as a grub screw, a press-fit rivet, or a pin. Many other types of fasteners are also applicable to this invention.

The pneumatic whistle may further comprise a whistle cap configured to inhibit an ingress of a fluid into the whistle flute, for example via a whistle port, when the whistle cap is placed on the whistle flute. The whistle cap may comprise a stopper configured to seal the whistle port. The whistle cap may be placed on the whistle flute when the pneumatic whistle is being prepared for cleaning. It may then be left on during cleaning, and during drying after cleaning. The whistle cap may then be removed once the whistle is clean and dry. The whistle cap may receive the whistle flute and retain the whistle flute when a protrusion, optionally an annular protrusion, on the whistle cap interfaces with a complimentary groove, optionally an annular groove on the whistle flute or whistle body. In other examples, the protrusion may be provided on the whistle flute and the groove on the whistle cap. The groove and protrusion may be circumferential with, for instance, V-shaped or U-shaped profiles. The whistle cap may be made from a deformable material such as silicone, rubber, thermoplastics etc. Alternatively, the stopper and/or the groove or protrusion may be made from a deformable material while the remainder of the whistle cap may be made from a different, optionally rigid, material. In some, the whistle cap may be shaped to push or press fit over the whistle flute to seal the entire whistle flute from fluid ingress, in such examples, the whistle cap may or may not include other retaining features such as the protrusion or groove.

In a further aspect, there is provided a pneumatic whistle, wherein the whistle body comprise a non-return valve assembly configured to: allow a pressurised fluid flow from a whistle fluid entry path to the whistle flute via a whistle fluid exit path; and inhibit a backflow of fluid towards the whistle fluid entry path. The non-return valve assembly may comprise: a valve biasing element and a valve seal, wherein the valve biasing element provides a biasing force to the valve seal so as to move the valve seal into the whistle fluid path, thereby inhibiting the backflow of fluid towards the whistle fluid entry path.

The biasing element may be, for instance, a spring or any other similar component capable of providing a force to the valve seal. The valve seal may, for instance, be a rubber ball with a diameter sufficiently large so as to completely obstruct the whistle fluid entry path. The valve seal may alternatively be made from a different material that is also capable of forming a seal against the whistle fluid entry path. The valve seal may seat against a valve seat in the whistle body.

The biasing of the valve biasing element may be overcome by a pressure of the whistle fluid flow in the whistle fluid entry path acting against the valve seal so as to move the valve seal out of the whistle fluid entry path (i.e., off the valve seat), thereby permitting the pressurised fluid flow from the whistle fluid entry path to the whistle flute. The biasing element may be provided on a valve frame. The valve frame may be operatively connected to the whistle body. The valve frame may be received by the whistle body into a threaded opening in the whistle body.

The valve frame may comprise an adjustment portion, whereby adjustment, such as rotation, of the adjustment portion causes the biasing force applied by the biasing element to the valve seal to be adjusted. A valve frame seal may be provided to inhibit a secondary ingress flow along a secondary ingress path, formed at an interface between the whistle body and the valve frame.

The adjustment portion may be an inset shape at a distal end of the valve frame, whereby a tool, such as a screwdriver, may be inserted and rotated to rotate the adjustment portion and thereby the valve frame. Rotation of the adjustment frame may cause the valve frame to move up or down the threaded opening of the whistle body.

The whistle flute may be permanently fixed to the whistle body. For instance, the whistle flute may be adhered or otherwise bonded to the whistle body, or the whistle flute may be press-fit into/around the whistle body. In other examples, the whistle flute may be connectable to the whistle body by other means, such as a threaded connection.

In a further aspect, there is provided a breathing apparatus comprising a pneumatic whistle as described above. Such a breathing apparatus may comprise equipment such as a face mask, a breathing gas tank, a pneumatic circuit, a lung demand regulator etc.

The aspects described herein provide a mechanism for preventing fluid ingress to a pneumatic whistle during cleaning, hence reducing the possibility of damage as a result of a liquid entering the pneumatic circuit.

### BRIEF DESCRIPTION OF THE DRAWINGS

Arrangements of the invention will now be described by way of example, with reference to the accompanying drawings, in which:

FIGS. 1A and 1B show cross sectional views of a pneumatic whistle known in the art;

FIGS. 2A and 2B show cross sectional views of a pneumatic whistle in accordance with an embodiment of the present invention; and

FIG. 3 shows a cross sectional view of a pneumatic whistle including a non-return valve in accordance with a further embodiment of the present invention.

### DETAILED DESCRIPTION OF THE INVENTION

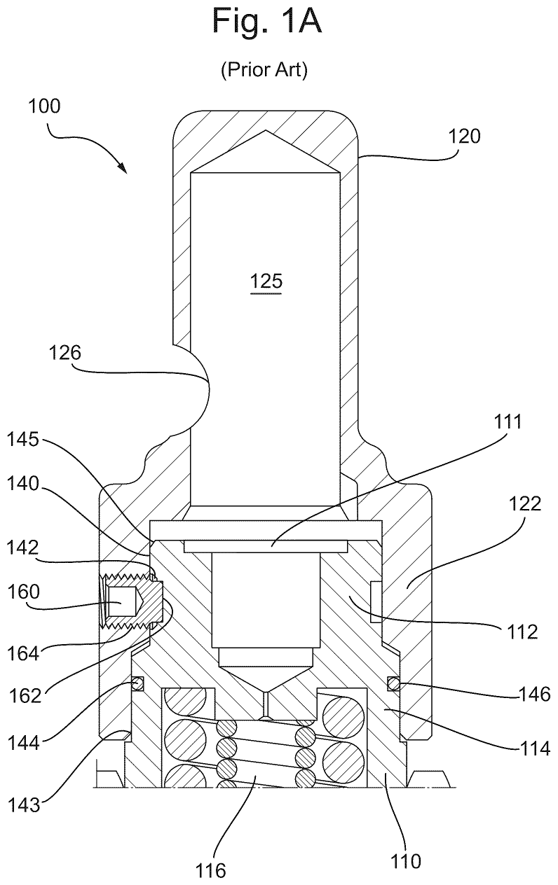

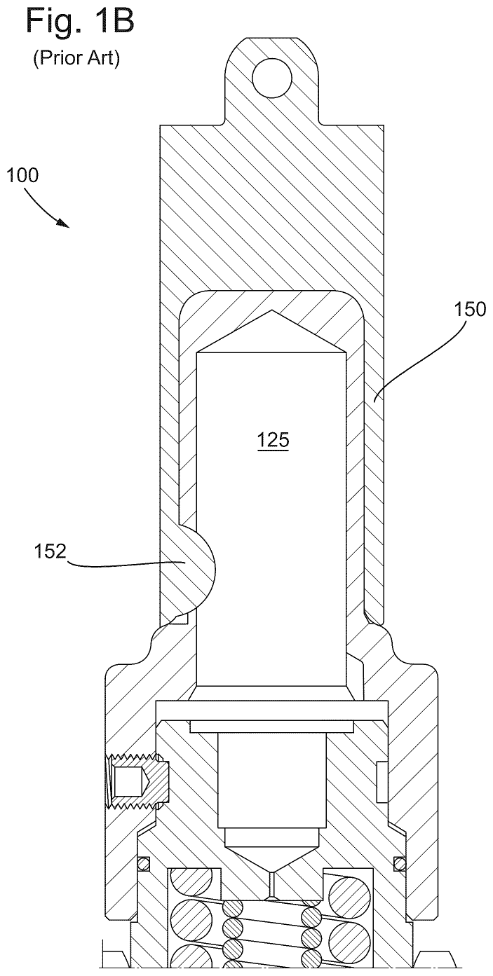

With reference to FIG. 1A and FIG. 1B an example of a pneumatic whistle 100 known in the art is shown. FIG. 1A shows the pneumatic whistle 100 without a cover, while FIG. 1B shows the pneumatic whistle 100 with a cover 150 installed over the whistle flute 120.

FIGS. 1A and 1B show the pneumatic whistle 100 comprising a whistle body 110 and a whistle flute 120. The whistle flute 120 comprises a receiving portion 122 which receives a protruding portion 112 of the whistle body 110. The interface between the protruding portion 112 and the receiving portion 122 forms a fluid ingress path 140. The fluid ingress path 140 is in communication with an internal chamber 125 of the whistle flute 120. The fluid ingress path 140 has an inlet point 143 at the exterior of the pneumatic whistle, and an outlet point 145 at the interior of the pneumatic whistle, i.e., at the internal chamber 125. The whistle body 110 also comprises an opening 111 which is in communication with the internal chamber 125. The opening 111 is an opening to the pneumatic circuit 116 which provides pressurised fluid to the pneumatic whistle 100 to produce an audible alarm sound.

A fastener 160 (in this example, a grub screw 160) is shown as being inserted through hole 164 in a distal end of the receiving portion 122. The end of the grub screw 160 sits in a seat 162 in a base of the protruding portion 112. The grub screw 160 prevents the protruding portion 112 from being removed from the receiving portion 122.

When the pneumatic whistle 100 comes into contact with a fluid, for instance, during cleaning, fluid may enter the fluid ingress path 140 at a number of locations. Fluid may enter through hole 164 around the sides of the grub screw 160, thereby forming a fluid ingress point 142. Fluid may also enter the fluid ingress path 140 at an inlet point 143 at the distal end of the receiving portion 122. When fluid enters the fluid ingress path 140 at fluid ingress point 142, it may flow downstream along the fluid ingress path 140 and into the internal chamber 125 via outlet point 145. Once in the internal chamber 125, the fluid is able to flow towards the opening 111 where the fluid can enter the pneumatic circuit 116.

Fluid that enters the fluid ingress path 140 at inlet point 143 is prevented from reaching the internal chamber and hence the opening 111 due to a seal 144 disposed in line with the fluid ingress path 140, sealing the interface between the protruding portion 112 and the receiving portion 122. The seal 144 presses against a seal seat 146. The seal is disposed downstream of inlet point 143, so can inhibit fluid flowing towards it. However, fluid that enters at fluid ingress point 142, has an unimpeded route to the outlet point 145, internal chamber 125 and on to opening 111. The fluid can then move from the internal chamber 125, through opening 111 and into the pneumatic circuit 116, potentially damaging the pneumatic circuit 116.

FIG. 1B shows the pneumatic whistle 100 with a cap 150 placed over the whistle flute 120. The cap 150 seals a whistle port 126 of the whistle flute 120 via a stopper 152 pressing into the whistle port 126. However, even with the cap 150 installed and the whistle port 126 scaled, fluid is still able to enter at the fluid ingress point 142 and enter the pneumatic circuit as discussed above.

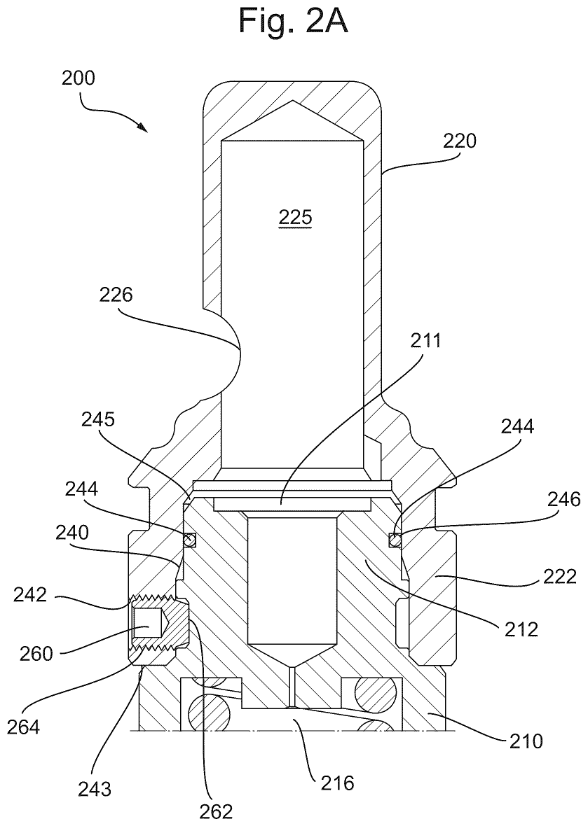

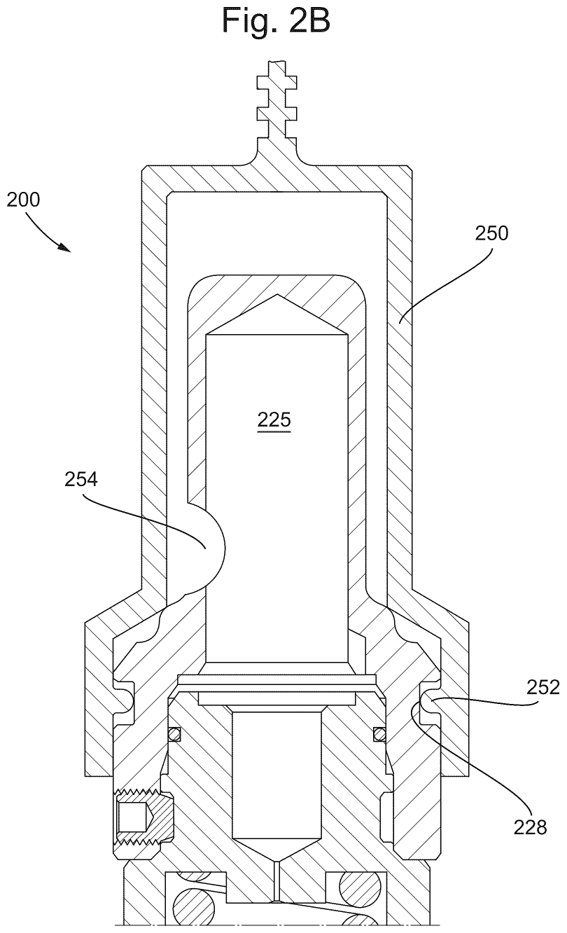

FIG. 2A and FIG. 2B show an example of a pneumatic whistle 200 according to the present invention. Corresponding features between FIGS. 1A/1B and FIGS. 2A/2B are indicated by reference numbers differing by 100. As with the pneumatic whistle 100 shown in FIGS. 1A and 1B, the pneumatic whistle 200 comprises a whistle body 210 and whistle flute 220. In the embodiment shown, the whistle body 210 comprises a protruding portion 212 which is received by a receiving portion 222 of the whistle flute 220. In other possible embodiments, the whistle body 210 comprises a receiving portion which receives a protruding portion of the whistle flute 220. Pneumatic whistle 200 also comprises a grub screw 260 threaded into a hole 264 through a distal end of the receiving portion 222 and into a seat 262 in a base of the protruding portion 212.

A fluid ingress path 240 is also defined as the interface between the protruding portion 212 and the receiving portion 222. Fluid may enter the fluid ingress path 240 at either a fluid ingress point 242 around the grub screw 260, or at an inlet point 243 at the distal end of the receiving portion 222. The fluid ingress path is in communication with an internal chamber 225 of the whistle flute 220. The internal chamber 225 is in communication with an opening 211 to the pneumatic circuit 216.

As shown, a seal 244 is disposed in line with the fluid ingress path 240, downstream of both the fluid ingress point 242 and inlet point 243. When the pneumatic whistle 200 comes into contact with a fluid, the fluid may enter the fluid ingress path 240 at fluid ingress point 242 and/or inlet point 243. However, as both fluid ingress point 242 and inlet point 243, are upstream of the seal 244 on the fluid ingress path 240, any fluid that does enter the fluid ingress path 240 is inhibited by the seal 244 from entering the internal chamber 225. As the fluid is unable to enter the internal chamber 225, it cannot enter the pneumatic circuit 216 via the opening 211. Therefore, the likelihood of damage occurring due to fluid entering the pneumatic circuit 216 is reduced.

As shown in FIG. 2B, a cap 250 can be placed onto the pneumatic whistle 200. The cap 250 is generally placed onto the whistle flute 220 of the pneumatic whistle 200 before cleaning and is kept in place after cleaning until the pneumatic whistle 200 is dry. In some embodiments, the cap 250 is kept in place until the pneumatic whistle is required for its next use.

The cap 250 includes a stopper 254 which seals a whistle port 226 of the whistle flute 220. The cap 250 also comprises an annular protrusion 252 which is configured to interface with a complementary annular groove 228 on an external surface of the whistle flute 220. Once the cap 250 is installed and the protrusion 252 and groove 228 are meshed, the cap 250 cannot be removed accidentally. For instance, the cap will not fall off when the pneumatic whistle 200 is inverted. The interfacing of the annular protrusion 252 and the complementary annular groove 228 forms a seal, thereby inhibiting fluid ingress at this point. In some embodiments, a stopper 254 is not provided, and instead fluid ingress into the fluid whistle is inhibited solely by the interfacing of the annular protrusion 252 and the complementary annular groove 228. In other examples, the whistle cap may be shaped so as to be push-or press-fit onto the whistle so as to be secured by friction alone, without the protrusion, groove, or stopper.

In many embodiments, the cap 250 is formed from a pliable material such as rubber, silicone, or plastic. This enables the annular protrusion 252 to be slightly stretched over the whistle flute 220 and then allowed to return to its original shape to securely grip the complementary annular groove 228. The cap 250 being formed of, for instance, rubber or silicone also enables the stopper 254 to form a secure seal with the whistle port 226, further reducing the chance of fluid ingress to the internal chamber 225.

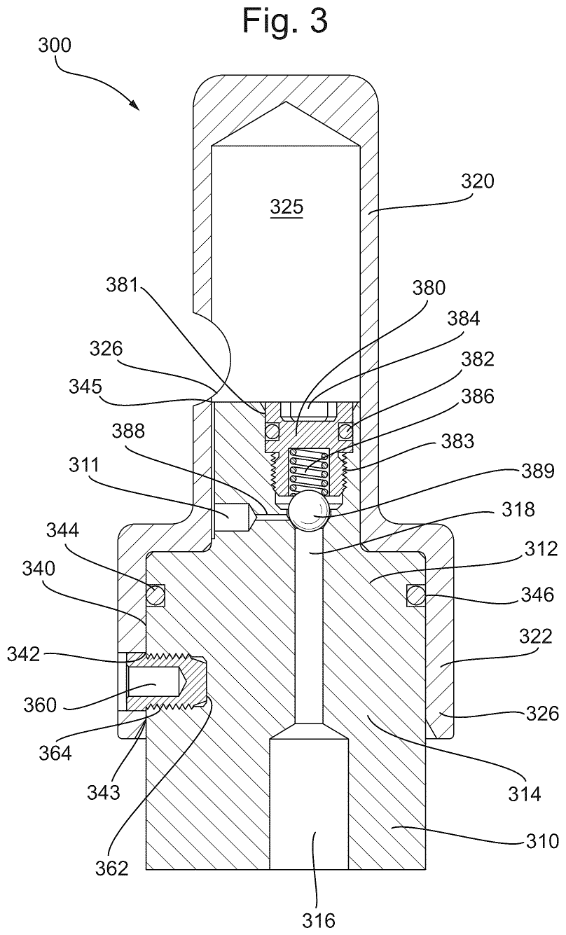

FIG. 3 shows a pneumatic whistle 300 according to a further embodiment of the present invention. Corresponding features between FIGS. 2A/2B and FIG. 3 are indicated by reference numbers differing by 100.

Apart from the seal 344, pneumatic whistle 300 also includes a non-return valve 380 to prevent fluid ingress during cleaning. The non-return valve is disposed between the opening 311 and a fluid entry path 318, separating the internal chamber 325 from the pneumatic circuit 316. During use of the pneumatic whistle 300, the non-return valve permits a pressurised fluid originating from the pneumatic circuit 316 to enter the internal chamber 325 of the whistle flute 320, thereby causing the whistle flute 320 to produce an audible alarm sound. The non-return valve also prevents any fluid in the internal chamber 325 from flowing back into the pneumatic circuit 316. Therefore, during cleaning, even if a fluid enters the internal chamber 325, the fluid cannot flow past the non-return valve and into the pneumatic circuit 316.

The non-return valve is disposed between a fluid entry path 318 and a fluid exit path 388. The entry path 318 allows pressurised fluid to flow from the pneumatic circuit 316 towards the non-return valve. The exit path 388 allows pressurised fluid to flow from the non-return valve to the opening 311 and into the internal chamber 325.

In the embodiment shown, the non-return valve comprises a valve frame 380, which is threadedly received by the whistle body 310 and thread 383. The valve frame 380 retains a spring 386. The spring 386 is biased to push downwards on a ball seal 389. The downward force of the ball seal 389 causes ball seal 389 to completely obstruct the entry path 318. When a pressurised fluid is introduced into the entry path 318 from the pneumatic circuit 316, the force of the pressurised fluid against the ball seal 389 causes the ball seal to move against the downward force provided by the spring 386. As a result, the entry path 318 becomes unobstructed and pressurised fluid flows through the non-return valve and into the internal chamber 325.

When a fluid is in the internal chamber 325, it is prevented from flowing back past the non-return valve and into the pneumatic circuit 316 as the ball seal 389 is only movable along a vertical axis (relative to the orientation shown in FIG. 3). Therefore, as the exit path 388 is connected to the non-return valve at the side, even if a pressurised fluid in the internal chamber 325 imparts a force on the ball seal 389, the seal will not move.

The interface between the valve frame 380 and the whistle body 310 forms a secondary ingress flow path 381. A seal 382 is provided to prevent any fluid that enters the secondary ingress flow path 381 from interfering with the non-return valve or from entering the entry path 318 and therefore the pneumatic circuit 316.

The valve frame 380 also comprises an adjustment portion 384. The adjustment portion 384 is configured to receive a tool such as a screwdriver or a hex key. The adjustment portion 384 can then be rotated in the whistle body 310 using the tool, causing the valve frame 380 to move up or down along the thread 383. As the valve frame 380 moves up or down, the degree to which the spring 386 is compressed, changes. Therefore, the force that the spring 386 imparts on the ball seal 389 is varied. Using this mechanism, the pressure at which a pressurised fluid in the entry path 318 will cause the non-return valve to open can be altered. The adjustment portion 384 can be accessed either through the whistle port 326 or from above when the whistle flute 320 is detached from the whistle body 310.

The pneumatic whistle 300 may also be used with a cap, such as the cap 250. However, such a cap is not always necessary as the non-return valve will inhibit fluid inside the internal chamber 325 from entering the pneumatic circuit. Nevertheless, a cap can still be used as an additional measure for redundancy.

It should be appreciated that the embodiments disclosed are just some examples of the many possible configurations in accordance with the present invention. When another configuration is used, it should be understood that the principles of the present disclosure could be applied and adapted to provide a mechanism for preventing fluid ingress during washing of a pneumatic whistle.

1. A pneumatic whistle for a breathing apparatus comprising:
a whistle body comprising an opening;
a whistle flute connected to the whistle body;
a fluid ingress path formed at an interface between the whistle body and the whistle flute;
a fastener configured to secure the whistle flute to the whistle body, the fastener forming a fluid ingress point on the fluid ingress path;
a sealing element configured to form a seal between the whistle body and the whistle flute on the fluid ingress path, so as to inhibit fluid ingress along the fluid ingress path beyond the sealing element;
wherein the sealing element is arranged downstream of the fluid ingress point along the fluid ingress path.

2. The pneumatic whistle of claim 1, wherein one of the whistle body and the whistle flute comprises a protruding portion and the other of the whistle body and the whistle flute comprises a receiving portion configured to receive the protruding portion so as to form the fluid ingress path at an interface between the protruding portion and the receiving portion.

3. The pneumatic whistle of claim 2, wherein the sealing element is disposed proximate a distal end of the protruding portion and seals against a seal seat on a surface of the receiving portion.

4. The pneumatic whistle of claim 2, wherein the fastener is installable through a hole proximate a distal end of the receiving portion and into a fastener seat in a base of the protruding portion.

5. The pneumatic whistle of claim 2, further comprising a whistle cap configured to inhibit an ingress of fluid into the whistle flute via a whistle port when the whistle cap is placed on the whistle flute.

6. The pneumatic whistle of claim 5, wherein the whistle cap receives the whistle flute and retains the whistle flute when a protrusion on the whistle cap interfaces with a complimentary groove on the whistle flute.

7. The pneumatic whistle as claimed in claim 1, wherein the whistle body further comprises a non-return valve assembly configured to: allow a pressurised fluid flow from a whistle fluid entry path to the whistle flute via a whistle fluid exit path; and inhibit a backflow of fluid towards the whistle fluid entry path from the whistle fluid exit path.

8. The pneumatic whistle as claimed in claim 7, wherein the non-return valve assembly comprises: a valve biasing element and a valve seal, wherein the valve biasing element provides a biasing force to the valve seal so as to move the valve seal into the whistle fluid exit path, thereby inhibiting the backflow of fluid towards the whistle fluid entry path.

9. The pneumatic whistle as claimed in claim 8, wherein the biasing of the valve biasing element is overcome by a pressure of the whistle fluid flow in the whistle fluid entry path acting against the valve seal so as to move the valve seal out of the whistle fluid exit path, thereby permitting the pressurised fluid flow from the whistle fluid entry path to the whistle flute.

10. The pneumatic whistle as claimed in claim 9, wherein the biasing element is provided on a valve frame, the valve frame being operatively connected to the whistle body.

11. The pneumatic whistle as claimed in claim 10, wherein the valve frame is received by the whistle body into a threaded opening in the whistle body.

12. The pneumatic whistle as claimed in claim 10, wherein the valve frame comprises an adjustment portion, whereby rotation of the adjustment portion causes the biasing force applied by the biasing element on the valve seal to be adjusted.

13. The pneumatic whistle as claimed in claim 11, wherein a valve frame seal is provided to inhibit a secondary ingress flow along a secondary ingress flow path at an interface between the whistle body and the valve frame.

14. The pneumatic whistle as claimed in claim 1, wherein the whistle flute is permanently fixed to the whistle body.

15. A breathing apparatus comprising a pneumatic whistle according to claim 1.
